(19) United States
(12) Patent Application Publication
(10) Pub. No.: US 2015/0019412 A1
(43) Pub. Date: Jan. 15, 2015

(54) METHOD AND SERVER FOR PROCESSING DATA

(71) Applicant: TENCENT TECHNOLOGY (SHENZHEN) COMPANY LIMITED, Shenzhen (CN)

(72) Inventors: SHUHONG ZHUO, Shenzhen (CN); XINYANG HUANG, Shenzhen (CN); HAN GU, Shenzhen (CN); WENQI DONG, Shenzhen (CN); YANGYAN WANG, Shenzhen (CN); SHUFEN LUO, Shenzhen (CN); HONGFU GUAN, Shenzhen (CN); XUEQING HOU, Shenzhen (CN); JUN XIE, Shenzhen (CN); YAN CUI, Shenzhen (CN); HUIAN WANG, Shenzhen (CN)

(73) Assignee: TENCENT TECHNOLOGY (SHENZHEN) COMPANY LIMITED

(21) Appl. No.: 14/341,616

(22) Filed: Jul. 25, 2014

Related U.S. Application Data
(63) Continuation of application No. PCT/CN2014/076855, filed on May 6, 2014.

(30) Foreign Application Priority Data
Jul. 11, 2013 (CN) 201310291273.1

(51) Int. Cl. G06Q 20/10; H04L 29/08

(52) U.S. Cl. CPC G06Q 20/10; H04L 67/10
USPC 705/39

(57) ABSTRACT

A method and a server for processing data are provided. A recharging request containing an account number for recharging is received. An interface of a recharging server is called to perform a first recharging process to the account number for recharging. It is then determined whether the first recharging process is completed within a pre-determined duration. When the first recharging process is not completed within the pre-determined duration, a second recharging process is performed to a compensating account corresponding to the account number for recharging. The server includes a recharging request module, a recharging interface calling module, a determining module, and a recharging module.

### CROSS-REFERENCES TO RELATED APPLICATIONS

This application is a continuation application of PCT Patent Application No. PCT/CN2014/076855, filed on May 6, 2014, which claims priority to Chinese Patent Application No. 201310291273.1, filed on Jul. 11, 2013, the entire contents of which are incorporated herein by reference.

### FIELD OF THE DISCLOSURE

The present disclosure relates to the field of data-processing technology and, more particularly, relates to a server and a method for processing data.

### BACKGROUND

As data-processing is widely used in social life based on network and computer, requirements of data-processing from users are significantly increased. Currently, a network operator provides users with network service via a server. For the network services such as recharging services, a user sends data request to the server of the network operator via a terminal. After receiving the data request, the server of the network operator performs processes corresponding to the data request according to a pre-set processing logic.

However, the network operator server may need to process a large amount of data requests and often the large amount of data requests sent from users may not be processed in time. The users may then need to re-send the data requests from terminals, or may give up the network service provided by the network operators via the server. Users re-sending the data requests from the terminals can significantly increase the burden on the server. The efficiency of the data-processing of the server is decreased. If the user gives up the network service provided by the network operators via the server, the network services provided by the server then are not fully used. The efficiency of the data-processing of the server is thus decreased and operational costs are increased.

FIG. 1 illustrates a flow diagram of a conventional recharging process via a recharging center. In the recharging process, a user sends a recharging request to the recharging center via a terminal (a). The recharging request is sent to the operator server by the recharging center (b). The operator server recharges a corresponding account (c). However, during the above recharging process, once the operator server cannot timely process the recharging requests from the users, for example, the account may not be recharged within 2 hours. Then the users need to send inquiry requests to the operator server. This further increases the load of the operator server and causes unpleasant user experience. The users may finally give up the recharging service provided by the operator server. Operational costs are increased.

### BRIEF SUMMARY OF THE DISCLOSURE

One aspect or embodiment of the present disclosure includes a method for processing data by a server. A recharging request containing an account number for recharging is received. An interface of a recharging server is called to perform a first recharging process to the account number for recharging. It is determined whether the first recharging process is completed within a pre-determined duration. When the first recharging process is not completed within the pre-determined duration, a second recharging process is performed to a compensating account corresponding to the account number for recharging.

Another aspect or embodiment of the present disclosure includes a server. The server includes a recharging request module, a recharging interface calling module, a determining module, and a recharging module.

The recharging request module is configured to receive a recharging request containing an account number for recharging. The recharging interface calling module is configured to call an interface of a recharging server to perform a first recharging process to the account number for recharging. The determining module is configured to determine whether the first recharging process is completed within a pre-determined duration. The recharging module is configured to perform a second recharging process to a compensating account corresponding to the account number for recharging, when the first recharging process is not completed in the pre-determined duration.

Another aspect of the present disclosure includes a non-transitory computer-readable medium having computer program. When being executed by a processor, the computer program performs a method for processing data by a server. The method includes receiving a recharging request containing an account number for recharging, calling an interface of a recharging server to perform a first recharging process to the account number for recharging, and determining whether the first recharging process is completed within a pre-determined duration. The method also includes, when the first recharging process is not completed within the pre-determined duration, performing a second recharging process to a compensating account corresponding to the account number for recharging.

Other aspects or embodiments of the present disclosure can be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the present disclosure.

FIG. 1 is a flow diagram illustrating a conventional recharging process via a recharging center;

FIG. 2 depicts an exemplary method for processing data by a server consistent with various disclosed embodiments;

FIG. 3 depicts an exemplary system for processing data consistent with various disclosed embodiments;

FIG. 4 depicts an exemplary method for processing data by a server consistent with various disclosed embodiments;

FIG. 5 depicts another exemplary system for processing data consistent with various disclosed embodiments;

FIG. 6 depicts an exemplary recharging process for telephone charge consistent with various disclosed embodiments;

FIG. 7 depicts an exemplary server consistent with various disclosed embodiments; and

FIG. 8 depicts an exemplary computer system consistent with the disclosed embodiments.

### DETAILED DESCRIPTION

Reference will now be made in detail to exemplary embodiments of the disclosure, which are illustrated in the accompanying drawings. Wherever possible, the same reference numbers will be used throughout the drawings to refer to the same or like parts.

As used herein, a terminal may refer to any appropriate user terminal device with certain computing capabilities, for example, a personal computer (PC), a work station computer, a notebook computer, a car computer (e.g., carrying in a car or other vehicles), a server computer, a hand-held computing device (e.g., a tablet computer), a mobile terminal (e.g., a mobile phone, a smart phone, an iPad, and/or an aPad), a POS (i.e., point of sale) device, or any other user-side computing device. In various embodiments, the terms “terminal” and “terminal device” can be used interchangeably.

As used herein, a server may refer one or more server computers configured to provide certain server functionalities, for example, search engines and database management. A server may also include one or more processors to execute computer programs in parallel. In various embodiments, the server can include any type of servers as disclosed herein.

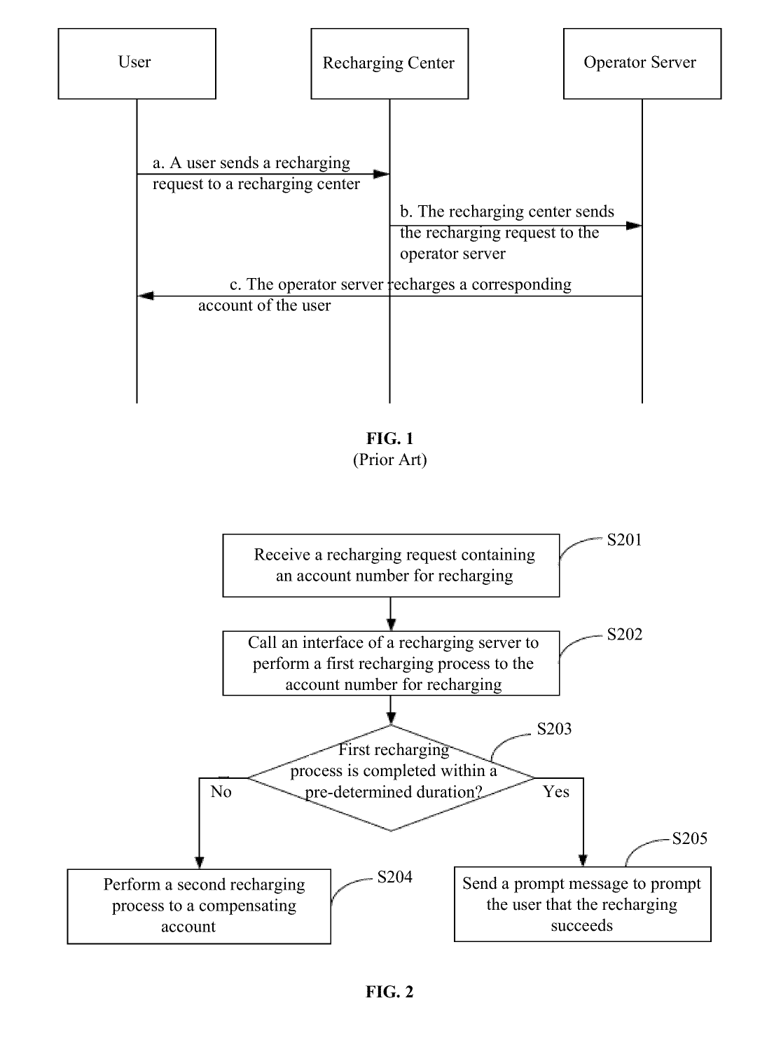

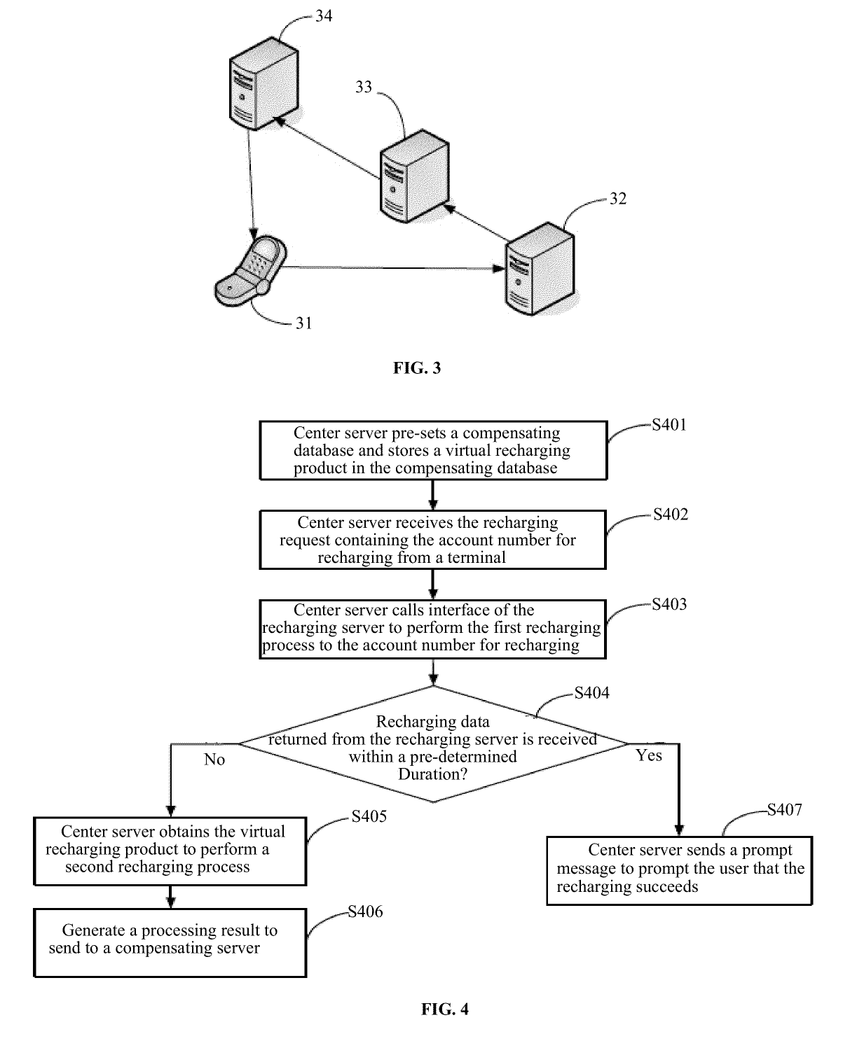

FIGS. 2-7 depict exemplary methods and apparatus (e.g., servers) for processing data in accordance with various disclosed embodiments. For example, FIG. 2 depicts an exemplary method for processing data by a server, while FIG. 3 depicts an exemplary system for processing data consistent with various disclosed embodiments. The exemplary system includes a center server 32, a recharging server 33, and/or a recharging platform 34.

In Step S201, a recharging request is received. The recharging request contains an account number for recharging. The account number for recharging can also be referred to as an account number for a to-be-recharged account of a user.

For example, referring to FIG. 3, when performing the telephone charge recharging, the user uses terminal 31 (e.g., a smart phone) to input the account number for recharging and the recharging money amount. The terminal 31 generates the recharging request including the account number for recharging and the recharging amount, and sends the recharging request to a center server 32. The account number for recharging can be a mobile phone number, a game account, and/or other suitable accounts. The terminal 31 is a communication terminal device used by the user using a network service. The terminal 31 can receive and send information by connecting to the network server via a communication network. The terminal 31 can be a desktop computer, a notebook computer, a workstation, a handheld computer, a UMPC (i.e., ultra mobile personal computer), a tablet computer, a PDA (i.e., personal digital assistant), a web pad, a portable phone, and any suitable terminal machines that can include a storage unit, a microprocessor, a computing capability, and/or other suitable functions.

The communication network can include any data communication network including, but not limited to, LAN (i.e., local area network), MAN (i.e., metropolitan area network), WAN (i.e., wide area network), Internet, etc. Additionally, the communication network can include phone network. The communication network can be wired or wireless. The communication network can use any suitable communication manners without limitation.

In Step S202, an interface of a recharging server is called to perform a first recharging process to the account number for recharging.

For example, referring to FIG. 3, when receiving the recharging request sent from the terminal 31, the center server 32 calls a corresponding interface of the recharging server to perform the first recharging process to the account number for recharging. The interface of the recharging server connects the recharging server 33, which is controlled and operated by a corresponding telephone charge supplier. The recharging server 33 is further connected to a recharging platform 34 and uses the recharging platform 34 to perform the recharging process to the account number for recharging. The recharging platform 34 may be the platform including CMCC or China Unicom.

In Step S203, whether the first recharging process is completed within a pre-determined duration is determined. When the first recharging process is not completed within the pre-determined duration, the method then proceeds to perform Step S204. When the first recharging process is completed within the pre-determined duration, the method then proceeds to perform Step S205.

For example, after the first recharging process to the account number for recharging is completed, the recharging server 33 returns recharging data to the center server 32. The recharging data include the account number for recharging, the recharging amount, the recharging time, etc. When the recharging data are received, the center server 32 determines that the first recharging process is completed to the account number for recharging. When the recharging data are not received, the center server 32 determines that the first recharging process is not completed to the account number for recharging.

In one embodiment, other methods can be used to determine whether the first recharging process is completed to the account number for recharging. The other methods may include, for example, determining an account balance of the account number for recharging, etc.

In Step S204, a second recharging process is performed to a compensating account associated with the account number for recharging. For example, the second recharging process to the compensating account can be performed by obtaining per-stored virtual recharging products. The compensating account corresponding to the account number for recharging can include, e.g., a QQ number, a game account number, etc.

As disclosed, the first recharging process and the second recharging process can correspond to different recharging products. For example, the first recharging process can include a recharging of mobile phone charge, and the second recharging process can include a recharging of a network virtual currency (e.g., an instant messaging account) to a virtual compensating account (e.g., the instant messaging account). Alternatively, the first recharging process can include a recharging of an online shopping account, and the second recharging process can include a recharging of a game account. Alternatively, the first recharging process can include a recharging of a game account, and the second recharging process can include a recharging of a mobile phone charge.

In one embodiment, the virtual recharging product can be pre-stored in the center server 32. When the center server 32 determines that the first recharging process is not completed within the pre-determined duration, the center server 32 can perform the second recharging process to the compensating account corresponding to the account number for recharging.

In Step S205, a prompt message is sent to prompt the user that the recharging is successful. For example, the prompt message can be sent by a method including: using a mobile phone to send a short message, using an associated instant messaging tool (e.g., QQ) to send, and/or using an associated email-box to send. The prompt message can include information such as recharging (money) amount, current account balance, etc.

As disclosed, when the first recharging process is not completed within the pre-determined duration, the second recharging process is performed to the compensating account corresponding to the account number for recharging. For example, when a telephone charge is not timely recharged to the account, the second recharging process, after obtaining virtual recharging product(s), can be performed to an application program account corresponding to the account number for recharging. This can avoid overloading of the server when recharging requests cannot be processed in time and users have to send more inquiry requests to the server. Further, user experience of the recharging service provided by the server can be ensured and more users can be maintained. Use efficiency of data provided by the server can be improved.

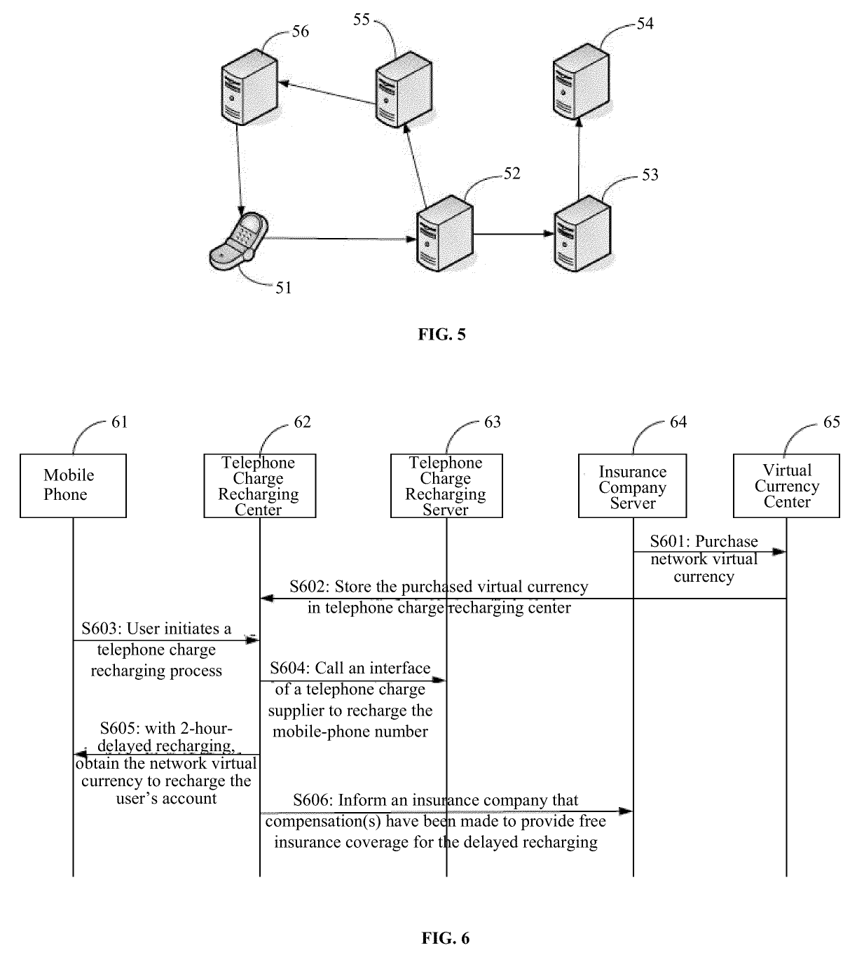

FIG. 4 depicts an exemplary method for processing data by a server, while FIG. 5 depicts another exemplary system for processing data consistent with various disclosed embodiments. The exemplary system for processing data includes a center server 52, a compensating server 53, a virtual product recharging server 54, a recharging server 55, and/or a recharging platform 56.

In Step S401, the center server 52 pre-sets a compensating database, and stores a virtual recharging product in the compensating database.

The virtual recharging products in the compensating database correspond to the compensating server 53. The compensating server 53 corresponds to the virtual product recharging server 54. Specifically, the virtual recharging products of the compensating database are provided by the virtual product recharging server 54.

For example, the compensating server 53 can include an operation server of an insurance company. The virtual product recharging server 54 can include a network virtual currency (e.g., QQ coins) server operated by an application program company. For example, the insurance company can purchase a certain amount of virtual currency from the virtual product recharging server 54 via the compensating server 53 operated by the insurance company, and can store the purchased virtual currency in the compensating database of the center server 52.

In Step S402, the center server 52 receives the recharging request from the terminal 51. The recharging request contains the account for recharging.

For example, when recharging the telephone charge, the terminal 51 can be used to input the account number for recharging, the recharging amount, etc. The terminal 51 can generate the recharging request including the account number for recharging and the recharging amount, and send the recharging request to the center server 52. The account number for recharging may include a mobile phone number and/or other suitable accounts such as a game account.

In Step S403, the center server 53 calls the interface of the recharging server to perform the first recharging process to the account number for recharging.

For example, referring to FIG. 5, when the center server 52 receives the recharging request from the terminal 51, the center server 52 can call a corresponding interface of the recharging server to perform the first recharging process to the account number for recharging. The interface of the recharging server can be connected to the recharging server 55. The recharging server 55 can be controlled to operate by a corresponding telephone charge supplier. The recharging server 55 can be further connected to the recharging platform 56. The recharging platform 56 can be a platform including, for example, CMCC or China Uniform. The recharging server 55 can call a correspondence interface of the recharging platform. The recharging platform 56 (e.g., a CMCC platform) corresponding to the interface of the recharging platform 56 can recharge the telephone charge to the account number for recharging.

In Step S404, the center server 52 determines whether recharging data returned from the recharging server 55 is received within a pre-determined duration. When the recharging data are received, the method proceeds to perform Step S407. Otherwise, when the recharging data are not received, the method proceeds to perform Step S405.

For example, after the first recharging process to the account number for recharging is completed, the recharging server 52 returns recharging data to the center server 52. The recharging data includes, e.g., the recharged account and the recharged amount. When the center server 52 receives the recharging data, the account number for recharging is indicated to be recharged by the first recharging process. When the center server 52 does not receive the recharging data, the account number for recharging is indicated not to be recharged by the first recharging process.

In Step S405, the center server 52 obtains the virtual recharging product from the pre-set compensating database to perform a second recharging process to the corresponding compensating account. The compensating account corresponds to the account number for recharging. The compensating account may include an account such as a QQ-number or the game account.

In various embodiments, more steps can be added, omitted, and/or altered. For example, the disclosed methods may further include that firstly the center server 52 determines whether the account number for recharging establishes a correlation with the compensating business provided by the compensating server. The center server 52 may pre-send a correlated message to the user to prompt the user whether to select the compensating business provided by the compensating server. When the user selects the compensating business provided by the compensating server, a correlation of the account number for recharging of this user with the compensating server can be established.

By this method, the user may desirably select whether he/she needs this compensating business. This may increase the user experience including, e.g., by using the insurance business provided by the server of the insurance company that is selected by the user. Of course, the second recharging process can be performed to recharge the virtual recharging product (e.g., an insurance business that can be for free trial) to the account number for recharging.

In Step S406, a processing result is generated and sent to the compensating server. The processing result corresponds to the second recharging process. For example, the processing result can include the compensating account, the compensating amount to the compensating account, etc. The compensating amount corresponds to the virtual recharging product.

In Step S407, the center server 52 sends a prompt message to the terminal 51 to prompt the user that the recharging succeeds.

For example, the prompt message can be sent by a method including: using a mobile phone to send a short message, using an associated instant messaging tool (e.g., QQ instant messaging) to send, and/or using an associated email-box to send the prompt message. The prompt message can include information such as recharging money amount, current account balance, etc.

FIG. 6 depicts an exemplary recharging process for telephone charge consistent with various disclosed embodiments.

In Step S601, insurance companies, banks, or other suitable financial institutions purchase a certain amount of network virtual currency (for example, QQ coins) from a virtual currency center 65 through an insurance company server 64.

In Step S602, the virtual currency center 65 stores the purchased virtual currency in a telephone charge recharging center 62.

In Step S603, a user uses a mobile phone 61 to initiate a telephone charge recharging process to the telephone charge recharging center 62.

In Step S604, the telephone charge recharging center 62 calls an interface of a telephone charge supplier and uses the telephone charge recharging server 63 of the telephone charge supplier to recharge the mobile phone number.

In one embodiment, during a peak time having too many telephone charge recharging requests, there is a probability that the recharging of the telephone charge may be delayed to the account number for recharging. When the telephone charge is instantly recharged, the telephone charge recharging center 62 can send a short message or use an instant messaging tool (e.g., QQ instant messaging) to send a message to the mobile phone.

In Step S605, when the telephone charge is delayed to the account number for recharging for about 2 hours, the telephone charge recharging center 62 obtains the virtual currency purchased by the insurance company to recharge the user's account (e.g., a QQ account).

In Step S606, the telephone charge recharging center 62 informs the insurance company that compensation(s) have been made for insuring the delayed recharging of the telephone charge to the account to be recharged.

When a user uses a terminal device (e.g., a mobile phone) to initiate a telephone charge recharging process online, often the recharging can be completed within a predetermined time duration (e.g., less than about 10 minutes, such as between about 1 minute and about 10 minutes, or less than about 1 minute) from the time when the telephone charge recharging process is initiated. In a case when the recharging is completed outside of the predetermined time duration, the recharging is referred to as a “delayed recharging”.

FIG. 7 depicts an exemplary server in accordance with various disclosed embodiments. The server exemplary includes a database setting module 71, a recharging request receiving module 72, a recharging interface calling module 73, a determining module 74, a recharging module 75, and/or a processing result sending module 76.

The database setting module 71 is configured to pre-set a compensating database, and to store a virtual recharging product in the compensating database. The virtual recharging product in the compensating database corresponds to a compensating server. When the user sends the recharging request including the account number for recharging and the recharging amount via a terminal, the recharging request receiving module 72 receives the recharging request, and the recharging interface calling module 73 calls a corresponding interface of the recharging server to perform the first recharging process to the account number for recharging. The first recharging process may include, e.g., recharging a mobile phone charge.

The determining module 74 is configured to determine whether the first recharging process is completed within a pre-determined duration. For example, the determining module 74 can determine by a method including: determining whether recharging data returned from the recharging server is received within the pre-determined duration. When the recharging data returned from the recharging server are not received within the pre-determined duration, the determining module 74 determines that the first recharging process to the account number for recharging is not completed within the pre-determined duration.

In one embodiment, the determining module 74 is further configured to determine whether the account number for recharging establishes a correlation with a compensating business provided by a compensating server, for example, by determining whether the user selects the delayed compensating business provided by the insurance company. When the determining module 74 determines that the account number for recharging establishes the correlation with the compensating business provided by the compensating server, when the first recharging process is not completed to the account number for recharging within the pre-determined duration, the recharging module 75 obtains the virtual recharging product to perform the second recharging process to the correspondence compensating account. The compensating account can correspond to the account number for recharging. The compensating account can be an associated account (e.g., a QQ account number) established a correlation with a mobile phone number (i.e., as the account number for recharging) or a game account number.

The processing result sending module 76 is configured to generate a processing result corresponding to the second recharging process, and to send the processing result to the compensating server. The processing result contains the compensating account and the compensating amount.

In various embodiments, when the first recharging process is not completed in the pre-determined duration, the second recharging process is performed to the compensating account corresponding to the account number for recharging. For example, when the telephone charge is not timely recharged to the desired account, the virtual recharging product can be obtained to perform the recharging process to an application program account (e.g., QQ number) corresponding to the account number for recharging. This can avoid overloading of the server when the recharging requests cannot be processed in time and users have to send more inquiry requests to the server. Further, user experience of the recharging service provided by the server can be ensured such that more users can be maintained. Use efficiency of data provided by the server can be improved.

In one embodiment, when online recharging an account number for a telephone charge, the user can obtain a free insurance coverage. When the recharging is delayed, compensation(s) (e.g., QQ coins) can be paid to an application program account (e.g., a QQ account).

For example, a user can initiate a telephone charge recharging process to the telephone charge recharging center. The telephone charge recharging center can call an interface of a telephone charge supplier and uses the telephone charge recharging server of the telephone charge supplier to recharge the user's account. During a peak time that has too many telephone charge recharging requests, there is a probability that the recharging of the telephone charge may be delayed to the account number for recharging. When the recharging is determined that completes, the user can receive a notification by a short message or a QQ message.

In various embodiments, when the user recharges the telephone charge, the recharging platform can “automatically” provide a free insurance coverage to the user for a delayed recharging. When the recharging is delayed, e.g., for about 2 hours, the telephone charge recharging center can inform an insurance company to compensate the user with an insurance payment for the delayed recharging. The insurance company can purchase a certain amount of, e.g., Ten cent Q coins. When delayed recharging occurs, the insurance company can compensate the user with Q coins. For example, the user can receive the compensation of 2Q coins in the user's QQ account.

As disclosed herein, the server can be, e.g., a terminal or a touch device. Exemplary terminal can be a computer, a tablet computer, a mobile phone having a touch function, etc. The server can be used in the disclosed method(s) for data processing. In other words, the method(s) for data processing can be implemented on the server without limitations.

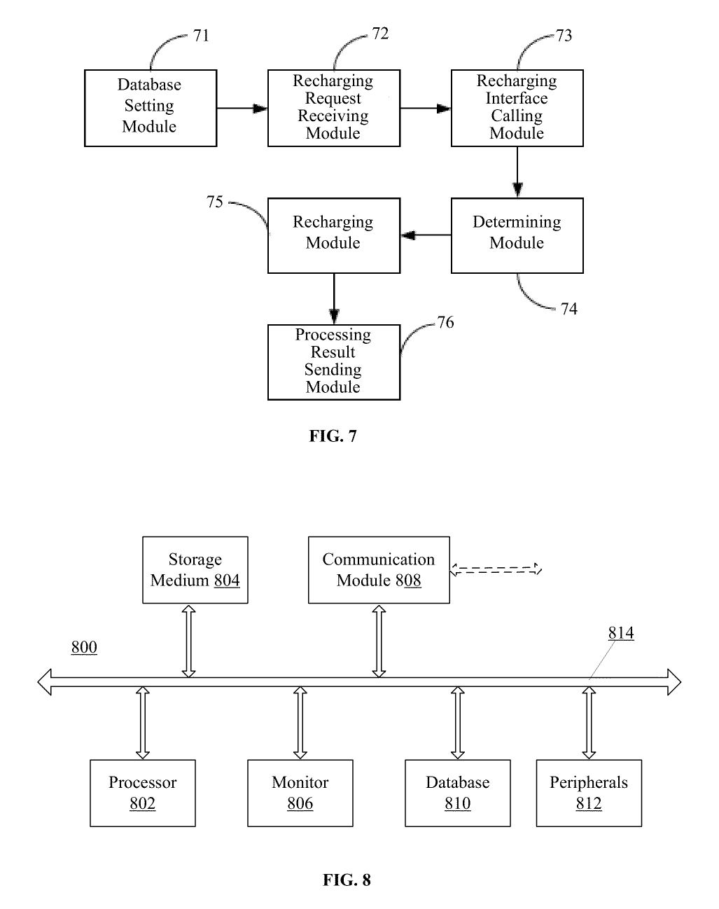

As used herein, server(s) and terminal(s) may be implemented on any appropriate computing/computer platform. FIG. 8 shows a block diagram of an exemplary computer system 800 capable of implementing the server(s) and/or the terminal(s).

As shown in FIG. 8, the exemplary computer system 800 may include a processor 802, a storage medium 804, a monitor 806, a communication module 808, a database 810, peripherals 812, and one or more buses 814 to couple the devices together. Certain devices may be omitted and other devices may be added.

The processor 802 can include any appropriate processor or processors. Further, the processor 802 can include multiple cores for multi-thread or parallel processing. The storage medium 804 may include memory modules, for example, ROM, RAM, and flash memory modules, and mass storages, for example, CD-ROM, U-disk, removable hard disk, etc. The storage medium 804 may store computer programs for implementing various processes, when executed by the processor 802.

Further, the peripherals 812 may include I/O devices, for example, keyboard and mouse, and the communication module 808 may include network devices for establishing connections through a communication network. The database 810 may include one or more databases for storing certain data and for performing certain operations on the stored data, for example, webpage browsing, database searching, etc.

In operation, the terminal may cause the server to perform certain actions, for example, an Internet search or other database operations. The server may be configured to provide structures and functions for such actions and operations. More particularly, the server may include a data searching system for real-time database searching.

It should be noted that, in the present disclosure each embodiment is progressively described, i.e., each embodiment is described and focused on difference between embodiments. Similar and/or the same portions between various embodiments can be referred to with each other. In addition, exemplary apparatus (e.g., a server) is described with respect to corresponding methods.

The disclosed methods, and/or apparatus can be implemented in a suitable computing environment. The disclosure can be described with reference to symbol(s) and step(s) performed by one or more computers, unless otherwise specified. Therefore, steps and/or implementations described herein can be described for one or more times and executed by computer(s). As used herein, the term “executed by computer(s)” includes an execution of a computer processing unit on electronic signals of data in a structured type. Such execution can convert data or maintain the data in a position in a memory system (or storage device) of the computer, which can be reconfigured to alter the execution of the computer as appreciated by those skilled in the art. The data structure maintained by the data includes a physical location in the memory, which has specific properties defined by the data format. However, the embodiments described herein are not limited. The steps and implementations described herein may be performed by hardware.

A person of ordinary skill in the art can understand that the modules included herein are described according to their functional logic, but are not limited to the above descriptions as long as the modules can implement corresponding functions. Further, the specific name of each functional module is used for distinguishing from on another without limiting the protection scope of the present disclosure.

As used herein, the term “module” can be software objects executed on a computing system. A variety of components described herein including elements, modules, units, engines, and services can be executed in the computing system. The apparatus, devices, and/or methods can be implemented in a software manner. Of course, the apparatus, devices, and/or methods can be implemented using hardware. All of which are within the scope of the present disclosure.

In various embodiments, the disclosed modules can be configured in one apparatus (e.g., a processing unit) or configured in multiple apparatus as desired. The modules disclosed herein can be integrated in one module or in multiple modules. Each of the modules disclosed herein can be divided into one or more sub-modules, which can be recombined in any manner.

One of ordinary skill in the art would appreciate that suitable software and/or hardware (e.g., a universal hardware platform) may be included and used in the disclosed methods and apparatus. For example, the disclosed embodiments can be implemented by hardware only, which alternatively can be implemented by software products only. The disclosed methods can be implemented partially or wholly using the software products (or computer program) to control certain hardware. The software products (or computer program) can be stored in a computer-readable storage medium including, e.g., ROM/RAM, magnetic disk, optical disk, etc. The software products can include suitable commands to enable a terminal device (e.g., including a mobile phone, a personal computer, a server, or a network device, etc.) to implement the disclosed embodiments.

Note that, the term “comprising”, “including” or any other variants thereof are intended to cover a non-exclusive inclusion, such that the process, method, article, or apparatus containing a number of elements also include not only those elements, but also other elements that are not expressly listed; or further include inherent elements of the process, method, article or apparatus. Without further restrictions, the statement “includes a . . . ” does not exclude other elements included in the process, method, article, or apparatus having those elements.

The embodiments disclosed herein are exemplary only. Other applications, advantages, alternations, modifications, or equivalents to the disclosed embodiments are obvious to those skilled in the art and are intended to be encompassed within the scope of the present disclosure.

### INDUSTRIAL APPLICABILITY AND ADVANTAGEOUS EFFECTS

Without limiting the scope of any claim and/or the specification, examples of industrial applicability and certain advantageous effects of the disclosed embodiments are listed for illustrative purposes. Various alternations, modifications, or equivalents to the technical solutions of the disclosed embodiments can be obvious to those skilled in the art and can be included in this disclosure.

A method and a server for processing data are provided. For example, a recharging request containing an account number for recharging is received. An interface of a recharging server is called to perform a first recharging process to the account number for recharging. It is then determined whether the first recharging process is completed within a pre-determined duration. When the first recharging process is not completed within the pre-determined duration, a second recharging process is performed to a compensating account corresponding to the account number for recharging. The server includes a recharging request module, a recharging interface calling module, a determining module, and a recharging module.

For example, when a telephone charge is not timely recharged to the account, the second recharging process, after obtaining virtual recharging product(s), can be performed to an application program account corresponding to the account number for recharging. This can avoid overloading of the server when recharging requests cannot be processed in time and users have to send more inquiry requests to the server. Further, user experience of the recharging service provided by the server can be ensured and more users can be maintained. Use efficiency of data provided by the server can be improved.

What is claimed is:

1. A method for processing data by a server, comprising:
receiving a recharging request containing an account number for recharging;
calling an interface of a recharging server to perform a first recharging process to the account number for recharging;
determining whether the first recharging process is completed within a pre-determined duration; and
when the first recharging process is not completed within the pre-determined duration, performing a second recharging process to a compensating account corresponding to the account number for recharging.

2. The method according to claim 1, further including:
before receiving the recharging request, pre-setting a compensating database and storing a virtual recharging product in the compensating database, wherein the virtual recharging product in the compensating database corresponds to a compensating server.

3. The method according to claim 2, further including:
before performing the second recharging processing to the compensating account corresponding to the account number for recharging, determining whether the account number for recharging establishes a correlation with a compensating business provided by the compensating server; and
when the account number for recharging is determined that establishes the correlation with the compensating business provided by the compensating server, obtaining the virtual recharging product to perform the second recharging process to the compensating account corresponding to the account number for recharging.

4. The method according to claim 2, wherein, after performing the second recharging process to the compensating account corresponding to the account number for recharging, the method further includes:
generating a processing result corresponding to the second recharging process, and
sending the processing result to the compensating server, wherein the processing result contains the compensating account.

5. The method according to claim 1, wherein determining whether the first recharging process to the account number for recharging is completed within the pre-determined duration includes:
determining whether recharging data returned from the recharging server is received within the pre-determined duration; and
when the recharging data returned from the recharging server is not received within the pre-determined duration, determining that the first recharging process to the account number for recharging is not completed within the pre-determined duration.

6. A server comprising:
a recharging request module, configured to receive a recharging request containing an account number for recharging;
a recharging interface calling module, configured to call an interface of a recharging server to perform a first recharging process to the account number for recharging;
a determining module, configured to determine whether the first recharging process is completed within a pre-determined duration; and
a recharging module, configured to perform a second recharging process to a compensating account corresponding to the account number for recharging, when the first recharging process is not completed within the pre-determined duration.

7. The server according to claim 6, further including:
a database setting module, configured to pre-set a compensating database and to store a virtual recharging product in the compensating database, wherein the virtual recharging product in the compensating database corresponds to a compensating server.

8. The server according to claim 7, wherein:
the determining module is further configured to determine whether the account number for recharging establishes a correlation with a compensating business provided by the compensating server; and
the recharging module is further configured, when the determining module determines that the account number for recharging establishes the correlation with the compensating business provided by the compensating server, to obtain the virtual recharging product to perform the second recharging process to the compensating account.

9. The server according to claim 7, further including:
a processing result sending module, configured to generate a processing result corresponding to the second recharging process, and to send the processing result to the compensating server, wherein the processing result contains the compensating account.

10. The server according to claim 6, wherein:
the determining module is also configured to determine whether recharging data returned from the recharging server is received within the pre-determined duration; and
the determining module is further configured, when the recharging data returned from the recharging server is not received within the pre-determined duration, to determine that the first recharging process to the account number for recharging is not completed within the pre-determined duration.

11. A non-transitory computer-readable medium having computer program for, when being executed by a processor, performing a method for processing data by a server, the method comprising:
receiving a recharging request containing an account number for recharging;
calling an interface of a recharging server to perform a first recharging process to the account number for recharging;
determining whether the first recharging process is completed within a pre-determined duration; and
when the first recharging process is not completed within the pre-determined duration, performing a second recharging process to a compensating account corresponding to the account number for recharging.

12. The non-transitory computer-readable medium according to claim 11, the method further including:
before receiving the recharging request, pre-setting a compensating database and storing a virtual recharging product in the compensating database, wherein the virtual recharging product in the compensating database corresponds to a compensating server.

13. The non-transitory computer-readable medium according to claim 12, the method further including:
before performing the second recharging processing to the compensating account corresponding to the account number for recharging, determining whether the account number for recharging establishes a correlation with a compensating business provided by the compensating server; and
when the account number for recharging is determined that establishes the correlation with the compensating business provided by the compensating server, obtaining the virtual recharging product to perform the second recharging process to the compensating account corresponding to the account number for recharging.

14. The non-transitory computer-readable medium according to claim 12, wherein, after performing the second recharging process to the compensating account corresponding to the account number for recharging, the method further includes:
generating a processing result corresponding to the second recharging process, and
sending the processing result to the compensating server, wherein the processing result contains the compensating account.

15. The non-transitory computer-readable medium according to claim 11, wherein determining whether the first recharging process to the account number for recharging is completed within the pre-determined duration includes:
determining whether recharging data returned from the recharging server is received within the pre-determined duration; and
when the recharging data returned from the recharging server is not received within the pre-determined duration, determining that the first recharging process to the account number for recharging is not completed within the pre-determined duration.
